(19) United States
(12) Patent Application Publication
(10) Pub. No.: US 2006/0209569 A1
(43) Pub. Date: Sep. 21, 2006

(54) Soft glow nightlight

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/085,327

(22) Filed: Mar. 21, 2005

(51) Int. Cl. H01R 33/00

(52) U.S. Cl. 362/641

(57) ABSTRACT

The present invention relates to a LED soft glow nightlight and more particularly, to a LED soft glow nightlight with a ultra-thin assembly by utilizing a simple light-emitting diode (LED) as a source of illumination and a transparent plastic film. When LED light passes through a transparent plastic film, it generates speeding clear light. The transparent plastic film allows light to form an evenly distributed glow, making it a safe and reliable way of illumination.

### BACKGROUND OF SAID PRESENT INVENTION

1. Field of Invention

The present invention relates to a LED soft glow nightlight and more particularly, to a LED soft glow nightlight with an ultra-thin assembly by utilizing a simple light-emitting diode (LED) as a source of illumination and a transparent plastic film. When LED light passes through a transparent plastic film, it generates speeding clear light. The transparent plastic film allows light to form an evenly distributed glow, making it a safe and reliable way of illumination.

2. Description of Related Arts

Currently, the directly plugged-in night lights generally include a light box. Inside the light box, there is an illuminant. A transparent window is installed on the light receiving surface of the box and on the back light side of the box there is an electric plug which is connected to the drive circuit of the illuminant. This electric plug is directly plugged into the power outlet on the wall or other power board with plugholes. Usually a 1.5 w-10 w white light bulb is used as the illuminant. The light illuminated by the small night light will be illuminated externally through the transparent window. The uneven light radiated will easily cause unpleasant feeling to the eyes during sleep at night and will affect sleep. In addition, the light bulb used will become hot and will burn children's hands. Thus, it is unsafe. Moreover, whit light bulb uses more energy and has short lifespan. It generally has to be replaced after 1000-1500 hours of use.

As disclosed in U.S. Pat. No. 4,343,032, a night light generally consists of a base portion having prongs, which directly plug into a wall outlet. The base portion has a neck extension, which receives a small wattage bulb. A plastic shade or canopy fits over the bulb and such structure provide a nigh night with a very bulky outfit.

White-light LED systems provide significant benefits over traditional fluorescent and incandescent lamps. As white light producing LED systems become more refined and efficient, a need exists to expand the use of such systems into other areas, such as night light. Conventional fluorescent and incandescent lamps used in night light have multiple components (increasing the cost to manufacture), are fragile, and have a relatively short operating life.

U.S. Pat. No. 6,641,283 discloses an illumination system includes an LED module or housing and a mounting base. A plurality of LEDs is mounted on the module to serve as a light source and generates a light pattern. At least one optical assembly is operatively associated with the housing for focusing and dispersing the light pattern. The housing can be easily mounted and removed from the base unit to provide a flexible mounting architecture. However, again due to the base is required by this LED illumination system, cost of production is higher and a bulky outfit of this LED illumination is a must.

U.S. Pat. No. 6,648,496 provides a night light assembly includes a wall plate adapted to fit over a switch plate extending from a substantially planar surface. The wall plate engages and abuts the substantially planar surface upon mounting the nightlight in its final operating position. At least one light emitting diode (LED) is mounted within the wall plate, which serves as the light source for the nightlight. This patent suggests a manner to provide a slimmer night light however, due to the nature of conventional LEDs, a relatively short-time-life of such LED illumination is remain an unsolved problems.

In order to overcome the above shortcomings, this new invention provides a evenly radiated small night light which does not cause unpleasant feeling to the eyes.

In order to achieve the purpose of this invention, the small night light in this invention uses a plastic base and a cover with light conducting hole in the center. Inside this light base there is at least one illuminant. The drive circuit of this illuminant is connected to the input terminal of the electric plug inside the base. The input terminal of the electric plug extends outside of the base to connect to the plug hole on the power supply. On the opening of the light conducting hole there is a light conductor. The light conductor includes a transparent light conducting board. This transparent light conducting board has a light receiving side and a back light side. The light receiving side has a light diffusion membrane which will distribute the light evenly. On the transparent light conducting board there is at least one empty chamber for storing the illuminant.

On the back light side of the transparent light conducting board there is one layer of light reflection membrane.

On the light receiving side of the transparent light conducting board there is one layer of light shade.

On both sides of the transparent light conducting board there is a light reflection membrane.

Since the back light side and all sides of the transparent light conducting board of the small night light in this new invention has a light reflection membrane, the light radiated by the illuminant is radiated through the light receiving side of the light conducting board. Because the light receiving side of the light conducting board has a light diffusion membrane, the light is not only even distributed through the light diffusion membrane but is soft and pleasant to the eyes. When an illuminant uses LED semi-conductor cold light bulb, it will not only prolong the lifespan of the small night light but will not burn the children's hands.

### SUMMARY OF SAID PRESENT INVENTION

A main object of the present invention is provide a LED soft glow nightlight by utilizing a simple light-emitting diode (LED) as a source of illumination and a transparent plastic film so as to provide a thin, slimmer outfit of a soft glow nightlight.

Another object of the present invention is provide a LED soft glow nightlight by utilizing a simple light-emitting diode (LED) as a source of illumination and a transparent plastic film simple light-emitting diode (LED) as a source of illumination and a transparent plastic film. When LED light passes through a transparent plastic film, it generates speeding clear light. The transparent plastic film allows light to form an evenly distributed glow, making it a safe and reliable way of illumination.

Another object of the present invention is provide a LED soft glow nightlight by eliminating all unnecessary components to a night light such as canopy, base and even switch plate so as to achieve an ultra thin LED soft glow nightlight with the least cost of production.

Accordingly, in order to accomplish the above objects, the present invention provides a LED soft glow nightlight, which comprises:

a housing consists of a front panel and a back panel,

a protective cover including an optical assembly for focusing and dispersing LED emitted light to a desired light contour enclosing at least a portion of the housing; and

at least one light-emitting diode (LED) as a illuminant, and

a plurality of circuit boards with a plurality of polyester cover capacitors, a plurality of resistances, a plurality of metal power plug, and

at least one transparent films, and

at least one protective semi transparent film, and

at least one piece of white film.

### BRIEF DESCRIPTION OF SAID DRAWINGS

FIG. 1 is a side sectional view of the present invention.

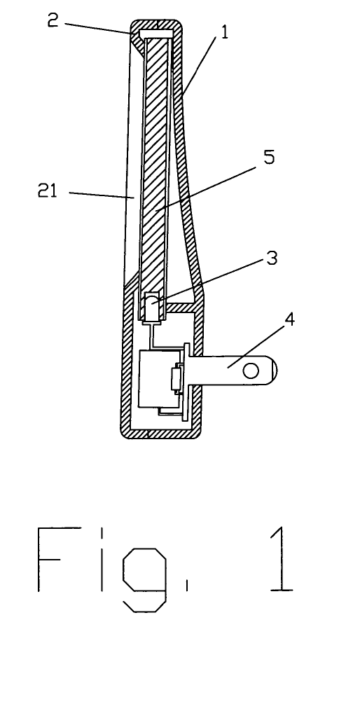

FIG. 2 is a guide light assembly view thereof.

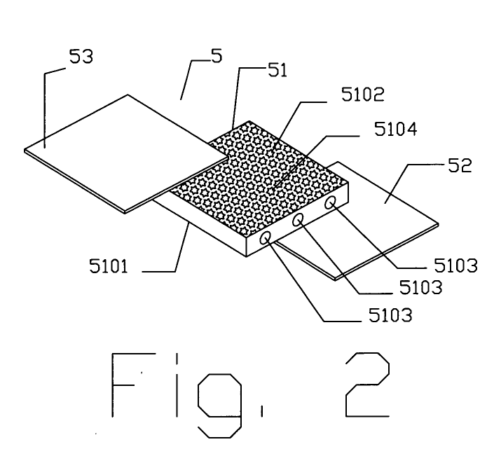

### DETAILED DESCRIPTION OF SAID PREFERRED EMBODIMENT

The small night light illustrated in Diagram 1 includes a plastic base (1), a light conducting hole (21) in the middle, a cover (2), and at least one illuminant (3) inside the base (1). The number of illuminant may be determined based on the needs or color requirement. For example, three illuminants may be installed and each is yellow, blue and white. The illuminant (3) may be a regular white light bulb. In this example, a LED semi-conductor cool light bulb is used. This cool light source consumes lower energy and has a longer lifespan. It does not generate heat. When children use it at night, it will not burn their hands. The illuminant (3)'s drive circuit is connected to the input terminal of the electric plug (4) inside the base (1). The input terminal of the electric plug (4) extends outside of the base (1) and is directly plugged into the external plugholes on the power outlet to power on. On the opening of the light conducting hole (21) there is a light conductor (5), which is illustrated in Diagram 2. The light beam radiated by the illuminant (3) is evenly conducted outward through the light conductor (5). The light conductor (5) includes a transparent light conducting board (51), a light reflection membrane (52) and a light shade (53). On the transparent light conducting board (51) there is a equivalent number of empty chamber (5103) as the illuminant (3). The empty chamber is used to cover the illuminant (3). The transparent light conducting board (51) has a back light side (5101) and a light receiving side (5102). On the surface of the light receiving side (5102) there is a light diffusion membrane (5104). This membrane allows the light radiated by the illuminant (3) to be evenly distributed. In order to further increase the comfortableness of night light, a layer of light shade (53) may be added to the outside layer of the light diffusion membrane (5104). In addition, in order to ensure that the light radiated from the illuminant (3) may be conducted outward by the light receiving side (5102) of the light conducting board, a light reflection membrane (52) may be attached to the back light side (5101) and all sides of the light conducting board.

What is claimed is:

1. A soft glow nightlight comprises:
a housing consists of a front panel and a back panel,
a protective cover including an optical assembly for focusing and dispersing LED emitted light to a desired light contour enclosing at least a portion of the housing; and
at least one light-emitting diode (LED) as a illuminant, and
a plurality of circuit boards with a plurality of polyester cover capacitors, a plurality of resistances,
a plurality of metal power plug is affixed on said circuit board and it passes through two hold on a lower portion of said back panel while said circuit board os affixed in between said front panel and back panel, and
at least one transparent films, and
at least one protective semi transparent film, and
at least one piece of white film.

2. A LED soft glow nightlight as recited in claim 1, wherein, said circuit board further comprises:
a plurality of metal polyester covering capacitors,
a plurality of resistances,
at least one diode and a plurality of light-emitting diodes.

3. A circuit board as recited in claim 1, wherein said LED soft glow nightlight provides an ability to adopt power source directly on any wall outlet of AC (alternate current), which is provided by any public utility provider.

4. A LED soft glow nightlight as recited in claim 1, wherein said front panel and back panel has no predetermined size and shape.

5. A LED soft glow nightlight as recited in claim 1, wherein surface of said front panel has a display window with a predetermined size and shape, which contains a transparent plastic film conforming with said predetermined size and shape of said hole.

6. A LED soft glow nightlight as recite in claim 1, wherein, as electrical current passes through said metal power plug into a circuitry that lowers down 120 voltages to a level that activates said light-emitting diodes and light is thereby transmitted. Said light passes through said transparent film, generates speed light, and said transparent plastic film allows light to form an evenly distributed glow, making it a safe and reliable way of illumination.

7. A LED soft glow nightlight comprises:
a housing consists of a front panel and a back panel,
a protective cover including an optical assembly for focusing and dispersing LED emitted light to a desired light contour enclosing at least a portion of the housing; and
at least one light-emitting diode (LED) as a illuminant, and
a plurality of circuit boards with a plurality of polyester cover capacitors, a plurality of resistances,
a plurality of metal power plug is affixed on said circuit board and it passes through two hold on a lower portion of said back panel while said circuit board os affixed in between said front panel and back panel, and
at least one transparent films, and
at least one protective semi transparent film, and
at least one piece of white film.
Wherein said circuit board further comprises:
a plurality of metal polyester covering capacitors,
a plurality of resistances,
at least one diode and a plurality of light-emitting diodes.

8. A circuit board for LED soft glow nightlight comprises:
a plurality of metal power plug, and
a plurality of metal polyester covering capacitors, and
a plurality of resistances, and
at least one diode and a plurality of light-emitting diodes. wherein, as electrical current passes through said metal power plug into a circuitry that lowers down 120 voltages to a level that activates said light-emitting diodes and light is thereby transmitted. Said light passes through said transparent film, generates speed light, and said transparent plastic film allows light to form an evenly distributed glow, making it a safe and reliable way of illumination.

9. A circuit board as recited in claim 7, wherein said LED soft glow nightlight provides an ability to adopt power source directly on any wall outlet of AC (alternate current), which is provided by any public utility provider.

10. A circuit board as recited in claim 8, wherein said LED soft glow nightlight provides an ability to adopt power source directly on any wall outlet of AC (alternate current), which is provided by any public utility provider.
